(19) United States
(12) Patent Application Publication
(10) Pub. No.: US 2013/0298881 A1
(43) Pub. Date: Nov. 14, 2013

(54) VARIABLE SPEED COMPRESSOR AND CONTROL SYSTEM

(71) Applicant: Xiaolan Ai, Massillon, OH (US)

(72) Inventor: Xiaolan Ai, Massillon, OH (US)

(73) Assignee: THE TIMKEN COMPANY, Canton, OH (US)

(21) Appl. No.: 13/981,719

(22) PCT Filed: Jan. 27, 2012
(86) PCT No.: PCT/US12/22887

§ 371 Date: Jul. 25, 2013

Related U.S. Application Data
(60) Provisional application No. 61/436,738, filed on Jan. 27, 2011.

(51) Int. Cl. F02B 39/10

(52) U.S. Cl. CPC F02B 39/10
USPC 123/565

(57) ABSTRACT

A variable speed compressor system (A) incorporating an electric power generation capability by combining a variable-speed compressor assembly (70) with an electric motor assembly (50) via a drive subassembly (30) in a compact unit regulated by a control system (400). The control system (400) facilitates fully controllable boost-on-demand forced-air induction operation across an entire engine speed range, and offers intelligent electric power generation.

### CROSS-REFERENCE TO RELATED APPLICATIONS

The present application is related to, and claims priority from, U.S. Provisional Patent Application Ser. No. 61/436,738 filed on Jan. 27, 2011, which is herein incorporated by reference.

### STATEMENT REGARDING FEDERALLY SPONSORED RESEARCH

Not Applicable.

### BACKGROUND OF THE INVENTION

The invention is related generally to a variable speed compressor system, and in particular, to a variable speed compressor and alternator in a compact unit coupled to an engine, with a related control structure to provide fully controllable boost-on-demand supercharging operation across an entire engine speed range together with intelligent electric power generation.

The increasing demand for fuel efficiency and emission reduction requires engines to provide higher output without increasing total piston displacement and weight. An effective way to achieve this goal is the use of forced air induction or compressor systems to boost the intake pressure. More air, and thus more fuel, can be added to each combustion cylinder within the engine. Consequently, more mechanical power is generated from each explosion in each cylinder.

There are two major types of forced air induction or compressor systems. One is referred to as supercharger and the other is referred to as turbocharger. The difference between the two systems is their source of energy. Turbochargers are powered by the mass-flow of exhaust gases driving a turbine; superchargers are powered mechanically by belt or chain drives from the engine crankshaft.

In general, superchargers offer performance and cost advantages over turbochargers. These advantages include no turbo lag and faster response, easy and inexpensive to install, and no introduction of a heat inertia effect in the exhaust system. This makes supercharger the most cost-effective way to increase engine power output.

Conventional superchargers are driven by engine's crankshaft through a fixed gear ratio or speed ratio. The boost ratio increases with engine speed. At low engine speed, the boost ratio is low; the in-take mass flow is insufficient to provide desired engine torque. Therefore, there is a strong desire to develop a variable speed supercharger that is capable of delivering optimal boost ratios across the entire spectrum of engine speed, providing additional engine torque even at low engine speeds.

### BRIEF SUMMARY OF THE INVENTION

Briefly stated, the present disclosure provides a variable speed compressor system along with an associated control system and structure. The variable speed compressor system incorporates electric power generation and storage capability by combining the compressor with an alternator in a compact unit for connection to an external battery or other energy storage device. The control system and structure facilitates fully controllable boost-on-demand air compression operation across entire engine speed range and offers intelligent electric power generation, such as is required to maintain a battery's state of charging (SOC).

In one embodiment of the present disclosure, a supercharger system of the present disclosure includes a three-shaft drive system, an electric machine, a supercharger compressor unit, and a controller that controls and operates the components of the supercharger system. The three-shaft drive system consists of an outer ring member, a sun member, at least one set of planetary members or clusters, and a carrier member. The three-shaft drive system serves as a power regulating device with its three shafts each connecting respectively to a drive pulley, the electric machine, and the compressor unit.

The controller of the supercharger system of the present disclosure is configured to implement a control system capable of offering at least three operating modes by controlling the operational status of the electric machine to suit various performance needs.

The first controlled mode of operation is the boosting mode, where the electric machine is controlled to rotate in an opposite direction relative to the direction of rotation of the drive pulley. The electric machine is in a motoring state, applying shaft torque in the same direction as the speed of rotation. The electric machine draws electric power from an external battery or energy storage system and delivers it to the three-shaft system providing drive power and shaft torque. The three-shaft drive system then combines the drive power with mechanical power from drive pulley and delivers the power to the supercharger compressor. In the boosting mode, the three-shaft drive system provides an increased speed ratio between the supercharger compressor and drive pulley. Therefore, even at relatively low engine speeds, the supercharger compressor is able to operate at a higher speed to provide high pressure forced air induction and to boost engine torque and power as required.

The second controlled mode of operation is a neutral mode where the electric machine is controlled to be at rest (zero rotational speed), generating virtually no electric power. This mode is used when significant engine boosting or forced air induction is generally not required and/or the battery system is in its full state of charge. In the neutral mode, the compressor-to-pulley speed ratio is essentially the same as the base speed ratio of the three-shaft drive system.

The third controlled mode is the charging mode, where the electric machine is controlled to rotate in the same rotational direction as the drive pulley. The electric machine is thus in the generating state, converting a portion of the mechanical power supplied from the drive pulley into electrical power to charge the battery system or provide power to another external energy storage device. In the charging mode, the three-shaft drive system provides a reduced compressor-to-pulley speed ratio, comparing with the base speed ratio of the drive system. In one example, the charging mode is used at vehicle high speed cruising, when engine speed is high and torque demand is relatively low.

The three operating modes are realized under a so-called speed control logic by the control system where the control objective is to achieve a desired speed of the variable-speed compressor or electric machine by controlling the shaft torque of the electric machine through a torque-based control structure. The control structure comprises at least one feedback loop which compares the measured or estimated speed of the compressor shaft to a reference speed of the compressor shaft and generates a drive torque command for the electric machine. The feedback loop includes a PID control unit whose gains are determined by, among others, the rotational momentums of system components. The torque-based control structure may further include a feed-forward loop to improve controllability. The feed-forward loop generates a base drive torque command for the electric machine based on the operation status of the variable-speed compressor. Under the base torque command, the variable speed compressor is able to maintain substantial torque equilibrium among the three shafts in the three-shaft drive system under steady state conditions.

The operation of the variable speed compressor may also be controlled under a torque control logic where the objective of the control structure is to achieve a desired torque level for the electric machine to generate electric power.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a schematic representation of a supercharger system of the present disclosure;

FIG. 2 is an axial layout representation of a three-shaft drive subassembly;

FIG. 3 is an exploded perspective sectional view of the three-shaft drive subassembly;

FIG. 4 is a speed ladder diagram for the variable speed supercharger illustrating the relationship between the compressor, pulley, and electric machine;

FIG. 5 is an axial layout representation of an alternate configuration for the three-shaft drive subassembly;

FIG. 6 is a speed ladder diagram for the variable speed supercharger having the alternate configuration of FIG. 5, illustrating the relationship between the compressor, pulley, and electric machine; and

FIG. 7 is a representation of the variable speed supercharger control structure of the present disclosure.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

While the compressor system of the present disclosure is described below in the exemplary embodiment in the context of a variable speed supercharger, those of ordinary skill in the art will recognize that the control system and features of the present disclosure may be utilizes with other types of variable speed compressor systems, such as turbochargers or turbines, and that such systems are considered to be within the scope of the present disclosure. In addition, while the engine of the present disclosure is described below in the exemplary embodiments as being an internal combustion engine which directly receives the forced air induction from the compressor system, those of ordinary skill in the art will recognize that other types of engines or sources of driving power may be utilized, and that the forced air induction from the compressor system may be routed to the benefit of other systems or components besides the engine.

Referring generally to (A) in FIG. 1, a variable speed compressor, such as a supercharger unit comprising a drive pulley subassembly 10, a three-shaft drive subassembly 30, an electric machine subassembly 50, and a supercharger subassembly 70 is shown. The drive pulley subassembly 10 contains a drive pulley 1, and a drive shaft 3 which is supported by a bearing assembly 5 on front casing 7.

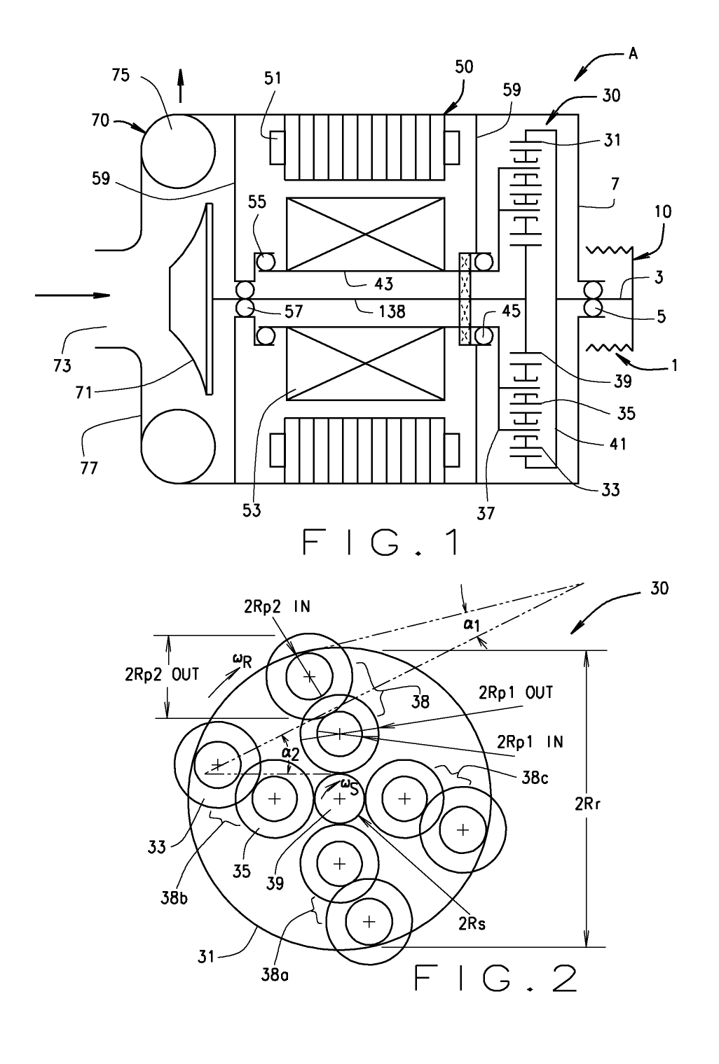

The three-shaft drive subassembly 30 is a double-wedged traction drive unit (See: FIG. 2 and FIG. 3), comprising an outer ring 31, a set of planet roller pairs 33 and 35, a planet carrier 37, and a sun shaft 39. The outer ring 31 is operatively coupled to the drive shaft 3 through a drive plate 41 (FIG. 1). The three-shaft drive subassembly 30 can take other forms, such as a conventional planetary gear drive or a planetary traction drive.

The electric machine subassembly 50 contains a stator 51 and a rotor 53. The rotor 53 is fixed onto the outer surface of a hollow shaft 43, which in turn is supported through bearings 45 and 55 by case 59. The hollow shaft 43 is connected to the planet carrier 37 of the three-shaft drive subassembly 30. Electrical connections are provide for operatively coupling the electric machine subassembly 50 to an external energy delivery and storage system (not shown), such as a battery.

The supercharger subassembly 70 is very similar to a variable-speed compressor commonly found in turbochargers. It includes a radial flow impeller 71 connected to the sun shaft 39 of the three-shaft drive system through a central shaft 138 which extends axially through the hollow shaft 43, an air inlet port 73 and an air outlet volute 75. The inlet port and outlet volute are integrated with a back case 77. The central shaft 138 at its end closer to the impeller is supported by case 59 through a bearing 57. As the impeller 71 spins at high speeds, air is drawn from the inlet port 73 and pushed out through the outlet volute 75 at increased pressure. Other types of supercharger compressors, such as scroll blower, screw blower, roots blower and vane blower, can also be used as the compressor subassembly of the current invention.

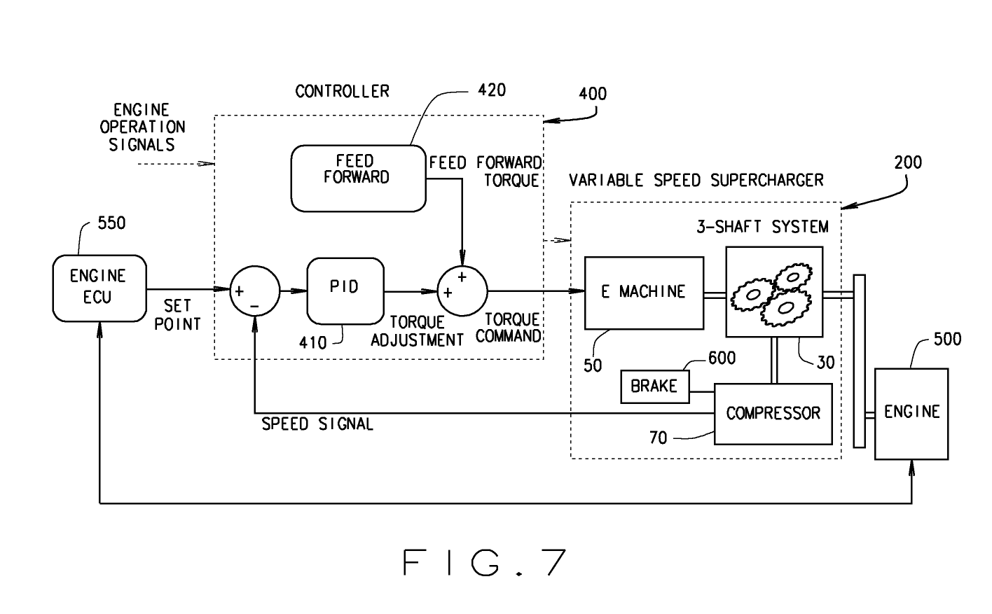

Optionally, the variable speed supercharger unit may further include a brake unit 600 (FIG. 7) to apply a stopping torque to the compressor and to prevent it from rotating when compressor's speed is too low or when it tends to rotate in an opposite direction. The brake unit 600 can be a frictional brake, a magnetic brake or even a one-way clutch.

Referring again to FIGS. 2 and 3, the three-shaft drive subassembly 30 is a double-wedge traction drive which features sets of stepped planet rollers 33, 35 for high or low speed ratio. Each set of planet rollers 33, 35 are paired and uniquely arranged to facilitate torque actuated self-loading in both rotational directions. The double-wedge traction drive has one or more sets of planet roller pairs 38, each comprising a first planet roller 35 and a second planet roller 33, each having a large cylindrical surface and a small cylindrical surface. The small cylindrical surface of the first planet roller 35 is in frictional contact with the large cylindrical surface of the second planet roller 33. The two planet rollers 33, 35 in a pair 38 are supported on a planet carrier 37 through bearings (33c, 35c) and pin shafts (33b, 35b) on a pair of brackets 34 disposed at opposite axial ends of the pin shafts.

The planet carrier is made of carrier base 37a and a carrier plate 37b. The carrier base has a set of bridges 37c for connecting with the carrier plate 37b, and a sleeve 37d for coupling with the hollow shaft 43 of the electric machine 50. On both the carrier base 37a and the carrier plate 37b there are recesses 37e and 37g and studs 37f and 37h. The pair of brackets 34 are supported on the studs 37f and 37h (see FIG. 3) of the planet carrier 37. During operation, each pair of brackets 34, along with the associated pair of planets 38 are free to rotate about the axis of the studs 37f, 37h.

During operation, the large cylindrical surface of the first planet roller 35 in each pair of planets 38 is in frictional contact with a large cylindrical surface of the sun shaft 39 at the axial center of the three-shaft drive subassembly 30. Correspondingly, the small cylindrical surface of the second planet roller 33 in each pair of planets 38 is in frictional contact with an inner cylindrical surface 32 of the outer ring 31, which is segmented in an axial direction by a groove 32a to accommodate the large cylindrical surface of the second planet rollers.

The base speed ratio of the traction drive shown in FIG. 2 and FIG. 3 is K=φ₁φ₂K₀, where the ratio of the outer diameter of the large cylindrical surface to the small cylindrical surface of the first planet roller is φ₁; the ratio of the outer diameter of large cylindrical surface to the small cylindrical surface of the second planet roller is φ₂; and the ratio of the diameter of the inner cylindrical surface of the outer ring to the diameter of the outer cylindrical surface of sun shaft is K₀. That is,

$$\begin{matrix}K = {φ}_{1} {φ}_{2} {K}_{0} & Eqn . ( 1 ) \\ {φ}_{1} = \frac{{R}_{p 1 \_ out}}{{R}_{p 1 \_ i n}} & Eqn . ( 2 ) \\ {φ}_{2} = \frac{{R}_{p 2 \_ out}}{{R}_{p 2 \_ i n} } \\ and & Eqn . ( 3 ) \\ {K}_{0} = \frac{{R}_{r}}{{R}_{s}} & Eqn . ( 4 )\end{matrix}$$

where:

Rₚ₁_{_{—}}ₒᵤₜ=radius of the large cylindrical surface of the first planet roller;

Rₚ₁_{_{—}}ᵢₙ=radius of the small cylindrical surface of the first planet roller;

Rₚ₂_{_{—}}ₒᵤₜ=radius of the large cylindrical surface of the second planet roller;

Rₚ₂_{_{—}}ᵢₙ=radius of the small cylindrical surface of the second planet roller;

Rᵣ=radius of the inner cylindrical surface of the outer ring,

R₂=radius of the outer cylindrical surface of the sun shaft

As can be seen, with stepped planet rollers, the base speed ratio of the traction drive is increased by a factor of φ=φ₁φ₂.

FIG. 2 also depicts the torque actuated self-loading mechanism of the traction drive 30. As the drive pulley 1 drives the outer ring 31 in the direction indicated by ω_{R}, it turns the sun shaft 39 in the same direction as indicated by ω_{S}. Now consider a pair 38 of planet rollers 33 and 35 in the traction drive assembly. The friction force exerting on the first planet roller 35 by the sun shaft 39 and the friction force exerting on the second planet roller 33 by the outer ring 31 forms a couple, which tends to rotate the planet roller pair 38 about the axis of the supporting studs 37f and 37h, between the sun shaft and the outer ring. Since the outermost distances between the large cylindrical surface of the first planet roller 35 and the small cylindrical surface of the second planet roller 33 is greater than an annular gap between the inner cylindrical surface of the outer ring 31 and the outer cylindrical surface of the sun shaft 39, a wedge action is created. The wedge action produces a substantial normal contact load at the various frictional contacts.

As seen in FIG. 2, the planet pairs 38 are arranged in two groups. Planet pairs in the same group are positioned anti-symmetrically about the axis of the sun shaft 39. Planet pairs in adjacent group are positioned symmetrically. This allows the traction drive to operate in both rotational directions.

When the outer ring 31 rotates clockwise, it drives the sun shaft 39 rotating in the same direction. The friction torque urges the planet pair 38 and the anti-symmetric planet 38a to pivot clockwise, wedging the planet pairs 38 and 38a between the outer ring 31 and the sun shaft outer circumference 39 to provide required normal contact load.

When the outer ring 31 rotates counterclockwise, it also drives the sun shaft 39 in the same direction. The friction torque urges the planet pair 38b and its anti-symmetric planet pair 38c to rotate counterclockwise, wedging the said planet pairs between the outer ring 31 and the sun shaft 39 to provide required normal contact load.

There are two wedge angles formed between the outer ring 31 and sun shaft 39. The first wedge angle, denoted by α₁, is formed for the second planet roller 33 between the outer ring 31 and the first planet roller 35. The second wedge denoted by α₂, is formed for the first planet roller 35 between the sun shaft 39 and the second planet roller 33. To prevent excessive slippage at frictional contacts, the following geometrical conditions are required:

$$\begin{matrix}tan ( \frac{{α}_{1}}{2} ) \leq μ & Eqn . ( 5 ) \\ tan ( \frac{{α}_{2}}{2} ) \leq μ & Eqn . ( 6 )\end{matrix}$$

where μ is the maximum available friction coefficient at the frictional contact.

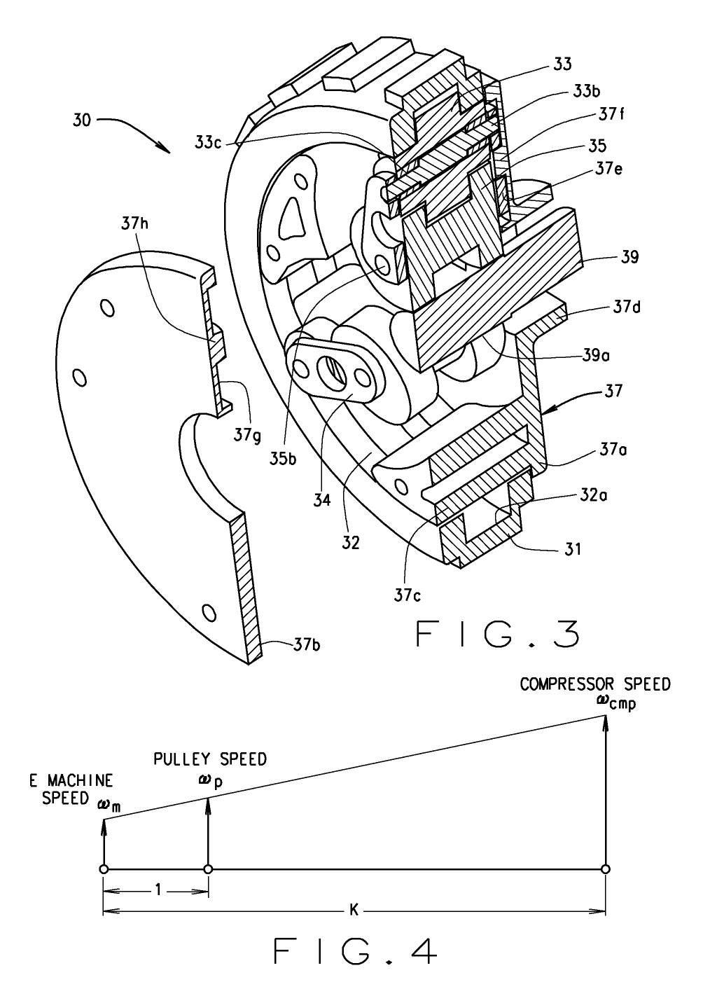

The traction drive so constructed has three concentric rotating members: (1) the outer ring member 31; (2) the planet carrier member 37; and (3) the sun shaft member 39. These three rotating members form the three-shaft drive system, having two degrees of freedom. The first shaft is the sun shaft member 39, which is connected to impeller 71. The second shaft is the outer ring member 31, which is connected to the drive shaft 3, and the third shaft is the planet carrier member 37 which is connected to the electric machine 50. The speed of the impeller 71 is determined by the speed of drive pulley 1 and the speed of rotor 53 of the electric machine 50. Thus, for a given drive pulley speed, which is proportional to engine speed, the speed of the impeller 71 can be adjusted by the electric machine 50 to meet boosting requirement. FIG. 4 is a speed ladder diagram for the variable speed supercharger of the present invention which illustrates the speed relationship among the impeller 71, the drive pulley 1, and the electric machine rotor 53.

There are other ways to construct a double-wedge traction drive system 30 having three concentric rotating members. FIG. 5 illustrates a layout diagram of an alternate double-wedge traction drive assembly 130. The alternate configuration drive assembly 130 has an outer ring 31, a set of paired planets 38, a carrier (not shown) and a sun shaft 39 which are substantially similar to those found in the traction drive system 30. The planet pair 38 includes a first stepped planet 35 having a large cylindrical surface and a small cylindrical surface, and a second stepped planet 33 having a large cylindrical surface and a small cylindrical surface. The small cylindrical surface of the first planet 35 is in frictional contact with the outer cylindrical surface of the sun shaft 39, while the large cylindrical surface of the second planet 33 is in frictional contact with the inner cylindrical surface of the outer ring 31. Between the first and second stepped planets 33, 35, the large cylindrical surface of the first planet 35 is in friction contact with the small cylindrical surface of the second planet 33.

The base speed ratio of the traction drive shown in FIG. 5 is K=K₀/(φ₁φ₂), where the ratio of the outer diameter of the large cylindrical surface to the small cylindrical surface of the first planet roller is φ₁; the ratio of the outer diameter of large cylindrical surface to the small cylindrical surface of the second planet roller is φ₂; and the ratio of the diameter of the inner cylindrical surface of the outer ring to the diameter of the outer cylindrical surface of sun shaft is K₀. That is:

$$K = \frac{{K}_{0}}{{φ}_{1} {φ}_{2 }} \qquad Eqn . ( 7 )$$

As one can see, with this arrangement, the base speed ratio of the traction drive is decreased by a factor of φ=φ₁φ₂.

Similarly to that found in the prior embodiment, the planet pairs 38 in FIG. 5 are arranged in groups. Planet pairs in a same group are arranged anti-symmetrically, while planet pairs 38 in adjacent group are symmetrically positioned to allow for bi-directional operation.

Other connecting configurations of the three-shaft drive system 30 to the compressor subassembly 70, the drive pulley 1, and the electric machine 50 are possible. For example, the compressor subassembly 70 can be alternatively connected to the planet carrier 37 of the traction drive unit 30; the rotor of the electric machine can be alternatively connected to the sun shaft 39 of the traction drive unit; and the drive pulley 1 to the outer ring member 31 of the traction drive unit 30.

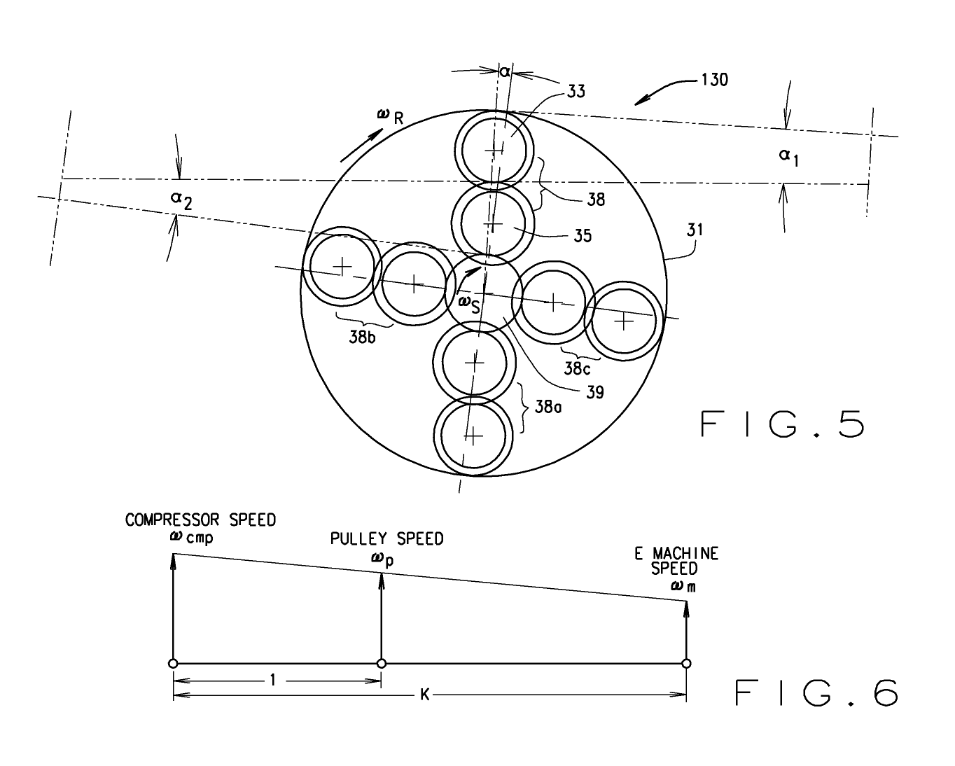

A speed diagram for the alternative configuration 130 of the traction drive unit of FIG. 5 is depicted in FIG. 6. The common feature in the speed diagrams among various configurations is that the drive pulley 1 is connected to the second branch or the middle shaft, of the three shaft drive system 30.

The operation of the variable speed supercharger system is controlled by a torque-based control structure shown in FIG. 7. The control structure incorporates the variable speed supercharger 200, a controller 400, the engine 500, and an engine electronic control unit 550. The controller 400 further includes a PID control unit 410 and an optional feed forward control unit 420. Input signals, such as the measured or estimated compressor speed, the reference compressor speed set point, engine speed, throttle position and other engine operation signals, are received by the controller 400, which produces at least an output torque command to control the operation of the electric machine 50 in concert with engine operation. The controller 400 conditions and processes input signals.

Specifically, the controller 400 compares a compressor speed signal to a set point, and produces a speed error signal if the speed of the compressor is not within a specified tolerance in reference with the set point. The speed error signal can be obtained simply as the differential between the measured speed signal and the reference set point. The PID control unit 410 receives the speed error signal as input and produces a torque adjustment signal by proportionally magnifying the error signal, integrating the error signal with respect to time or taking the time derivative of the speed error signal. The PID control unit 410 may have three separate and parallel paths, corresponding to proportional magnification, integration, and differentiation. The output signal of the PID control unit 410 combines signals from all three paths.

Alternatively, controller 400 itself may produce the reference compressor speed set point based on engine operation signals, such as engine speed and throttle position.

The optional feed-forward unit 420 receives input associated with the compressor operation status, and estimates a reference torque for the electric machine 50. The reference torque is also known as the feed forward torque or the base torque. The operation status of compressor includes, but not limited to, compressor speed, compressor torque load and compressor power consumption. The reference torque is estimated under steady-state conditions such that by applying the reference torque to the electric machine, the three shaft system would achieve substantial torque equilibrium. The torque command for the electric machine 50 is then composed of the reference torque signal and the torque adjustment signal.

For a connection configuration represented by FIG. 4, the reference torque is estimated as:

T_{ref}_{_{—}}ₑₘ=(K−1)·T_{cmp}(ω_{cmp}) Eqn. (8)

where T_{cmp} is the compressor torque load which is a function of compressor speed ω_{cmp}. K is the base speed ratio of the three-shaft drive system 30 (See: FIG. 4). The total torque command for the electric machine 50 is:

$${T}_{set \_ em} = {T}_{ref \_ em} + {G}_{P} \cdot Δ ω + {G}_{I} \cdot \int Δ ω d t + {G}_{D} \cdot \frac{\partial ( Δ ω )}{\partial t} \qquad Eqn . ( 9 )$$

where G_{P}, G_{I}, and G_{D} are gains of the PID control unit 410, Δω is the speed error between the reference compressor speed (set point) ω_{cmp}and the actual measured compressor speed ω_{act}.

For a connection configuration represented by FIG. 6, the reference torque is estimated as:

$${T}_{ref \_ em} = ( \frac{1}{K - 1} ) \cdot {T}_{cmp} ( {ω}_{cmp} ) \qquad Eqn . ( 10 )$$

The total torque command for the electric machine 50 is calculated using the same equation as Equation (9).

To protect the electric machine 50 from being overloaded, the torque command Tₛₑₜ_{_{—}}ₑₘ may be monitored and limited by a current saturation device (not shown) either inside or outside of said controller 400. When a torque command exceeds the set limits, the signal is held at the set level until the torque command drop below or within the set level.

The objective of the operation and control of the variable speed supercharger described so far is to control the speed of the compressor 71 or the electric machine 50 such that desired pressure ratio can be achieved. This control logic is referred to as the speed control logic.

The controller 400 may be constructed to also provide a braking signal to a brake unit 600 based on engine operation status and on compressor operation status. When it deems that the compressor 71 ought to be stopped for safe or desired operation, a brake signal is issued. The brake unit 600 coupled to the variable speed supercharger unit 70 in turn applies a stopping torque to stop and hold the compressor 71. Under such conditions, the speed of the compressor 71 is zero and is not really changeable to other speeds. The objective of the operation and control is therefore not to control compressor speed, rather to control the torque of the electric machine 50 to provide suitable charging conditions for an external battery system (not shown). When the shaft 38 of the compressor 71 is rotationally locked, the operation and control of the electric machine 50 is very similar to that of a conventional alternator. The controller is thus operated under so-called torque-control logic.

When the shaft 138 of compressor 71 is locked, it is also possible to use the electric machine 50 to start the engine 500, in this case the electric machine 50 functions as a conventional starter device.

During the operation, speed-control logic and torque-control logic may be switched back and forth based on operation conditions. The two control logic may be handled by two separate control units within the controller 400 or by single unit in the controller 400.

Alternatively, the braking signal can be an input signal from the engine ECU 550, and the controller 400 configured to switch back and forth between the speed-control logic and the torque-control logic based on a received braking signal.

It is always desirable to restrict the power ratings of the electric machine 50. Smaller electric machines not only reduces physical size but also reduced the cost for both electric machine itself and for its power electronic systems. To this end, it is recommended for connect configuration shown in FIG. 4, the following relationship be held:

$$\vert \frac{( \frac{{K}_{p} K}{SR} - 1 ) \cdot {P}_{cmp}}{{P}_{cmp \_ ma x}} \vert \leq 1 \qquad Eqn . ( 11 )$$

where:

Kₚ is rotational speed ratio of the speed of the drive pulley shaft 3 to speed of the engine crank shaft, Kₚ=ωₚ/ω_{eng};

K is the base ratio of three-shaft drive system 30;

SR is the speed ratio of the speed of the compressor shaft 138 to the speed of the engine crank shaft SR=ω_{cmp}/ω_{eng};

P_{cmp} is the compressor power;

P_{cmp}_{_{—}}ₘₐₓ is the maximum power of compressor;

ωₚ denotes pulley shaft speed;

ω_{cmp} denotes compressor speed; and

ω_{eng} denotes engine speed.

For connection configuration shown in FIG. 6, the following relationship is recommended:

$$\vert \frac{[ ( \frac{{K}_{p} K}{K - 1} ) \frac{1}{SR} - 1 ] \cdot {P}_{cmp}}{{P}_{cmp \_ ma x}} \vert \leq 1 \qquad Eqn . ( 12 )$$

The definitions of symbols in above equation are the same as in Equation (11).

Other means of grouping and processing signals are possible, they should not be considered as deviation from the spirit of current invention. The present disclosure can be embodied in-part in the form of computer-implemented processes and apparatuses for practicing those processes or in the form of embedded systems. The present disclosure can also be embodied in-part in the form of computer program code containing instructions embodied in tangible media, such as solid-state memory devices, CD-ROMs, hard drives, or another computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, such as over electrical wiring, cabling, or busses, through fiber optics, or via electromagnetic radiation, wherein, when the computer program code is loaded into and executed by a computer, the computer becomes an apparatus for practicing the present disclosure. When implemented in a general-purpose microprocessor or an embedded system, the computer program code segments configure the microprocessor to create specific logic circuits and/or to provide output control signals.

As various changes could be made in the above constructions without departing from the scope of the disclosure, it is intended that all matter contained in the above description or shown in the accompanying drawings shall be interpreted as illustrative and not in a limiting sense.

1. A variable speed compressor system for use with an engine, comprising:
a drive shaft;
a variable-speed compressor subassembly including an variable-speed compressor mounted to a compressor shaft;
an electrical machine subassembly including a stator and a rotor;
a three-shaft drive system operatively coupling the shaft of the variable-speed compressor subassembly, the rotor of the electrical machine, and the drive shaft; and
a torque-based control system configured to control and operate the variable-speed compressor subassembly and the electrical machine subassembly.

2. The variable speed compressor system of claim 1 further including a brake unit coupled to the compressor subassembly, said brake unit configured to apply a stopping torque to the compressor and shaft under selected operating conditions.

3. The variable speed compressor system of claim 1 wherein said three-shaft drive system consists of an outer ring, at least one set of planet pairs, a planet carrier, and a sun shaft.

4. The variable speed compressor system of claim 3 wherein said outer ring is operatively coupled to said drive shaft, said planet carrier is operatively coupled to said rotor, and said sun shaft is operatively coupled to said compressor shaft.

5. The variable speed compressor system of claim 3 wherein said outer ring is operatively coupled to said drive shaft, said planet carrier is operatively coupled to said compressor shaft, and said sun shaft is operatively coupled to said rotor.

6. The variable speed compressor system of claim 3 wherein said three-shaft drive system is a double-wedge traction drive unit configured for bi-directional operation.

7. The variable speed compressor system of claim 3 wherein said three-shaft drive system includes two groups of planet pairs, each group including at least two planet pairs, wherein planet pairs in a common group are position anti-symmetrically about an axis of said sun shaft, and wherein planet pairs in adjacent groups are positioned symmetrically about said axis of said sun shaft.

8. The variable speed compressor system of claim 7 wherein planet pairs in a first group are configured to pivot in a first direction in response to rotation of the outer ring in the same first direction, wedging the planet pairs between the outer ring and the sun shaft, providing normal contact load; and
wherein planet pairs in a second group are configured to pivot in a second direction in response to rotation of the outer ring in the same second direction, wedging the planet pairs between the outer ring and the sun shaft, providing normal contact load.

9. The variable speed compressor system of claim 1 wherein said torque-based control system includes a PID control unit configured to receive one or more input signals, and to produce at least one output torque signal to control the operation of the electric machine.

10. The variable speed compressor system of claim 9 wherein said one or more input signals are selected from a set of input signals including measured compressor speed, estimated compressor speed, a reference compressor speed set point, compressor speed error, an engine speed, a throttle position, and engine operating parameters.

11. The variable speed compressor system of claim 9 wherein said PID control unit is configured to process said one or more input signals for comparison to a selected set point, and is further configured responsive to detected deviation exceeding a tolerance, to produce said at least one output torque signal in the form of a torque adjustment signal to said electric machine.

12. The variable speed compressor system of claim 11 further including a feed-forward unit, said feed-forward unit configured to receive one or more compressor operational status inputs and further configured to generate a reference torque signal; and
wherein said torque output signal is composed of said reference torque signal and said torque adjustment signal.

13. The variable speed compressor system of claim 12 wherein said one or more compressor operational status inputs include, but are not limited to, compressor speed, compressor torque load, and compressor power consumption.

14. The variable speed compressor system of claim 12 wherein said reference torque signal represents a reference torque applied to the electric machine which would place the three-shaft drive system in substantial torque equilibrium under a steady-state operational condition.

15. The variable speed compressor system of claim 12 wherein said feed forward unit is configured to estimate said reference torque as:
T_{ref}_{_{—}}ₑₘ(K−1)·T_{cmp}(ω_{cmp})
where T_{cmp} is the compressor torque load which is a function of compressor speed ω_{cmp}, and K is the base speed ratio of the three-shaft drive system.

16. The variable speed compressor system of claim 12 wherein said feed forward unit is configured to estimate said reference torque as:
$${T}_{ref \_ em} = ( \frac{1}{K - 1} ) \cdot {T}_{cmp} ( {ω}_{cmp} )$$
where T_{cmp} is the compressor torque load which is a function of compressor speed ω_{cmp}, and K is the base speed ratio of the three-shaft drive system.

17. The variable speed compressor system of claim 12 wherein said torque output signal for the electric machine is:
$${T}_{set \_ em} = {T}_{ref \_ em} + {G}_{P} \cdot Δ ω + {G}_{I} \cdot \int Δ ω d t + {G}_{D} \cdot \frac{\partial ( Δ ω )}{\partial t}$$
where G_{P}, G_{I}, and G_{D} are gains of the PID control unit, and Δω is the speed error between the reference compressor speed (set point) ω_{act} and the actual measured compressor speed ω_{cmp}.

18. The variable speed compressor system of claim 9 wherein said control system is further configured to produce a braking signal to a braking unit operatively coupled to said compressor subassembly.

19. The variable speed compressor system of claim 18 wherein said control system is further configured to control said electric machine to drive said drive shaft when said compressor subassembly is locked by said braking unit in response to said braking signal.

20. The variable speed compressor system of claim 1 wherein said torque-based control system is configured to control and operate the compressor subassembly and the electrical machine subassembly in at least three modes of operation, including
a first mode of operation wherein said electric machine is in a motoring state and supplies power to said compressor shaft;
a second mode of operation wherein said electric machine is at rest; and
a third mode of operation wherein said electric machine is in a generating state, converting power from said rotating drive shaft to electrical power, charging a battery system.

21. The variable speed compressor system of claim 1 wherein said variable-speed compressor is a supercharger.

22. The variable speed compressor system of claim 1 wherein said variable-speed compressor is a turbocharger.
